(19) United States
(12) Patent Application Publication
(10) Pub. No.: US 2025/0310760 A1
(43) Pub. Date: Oct. 2, 2025

(54) Dynamic Virtual Local Area Network Provisioning

(71) Applicant: Arista Networks, Inc., Santa Clara, CA (US)

(72) Inventors: Venkata Ramchandra Murthy Jonnalagadda, Fremont, CA (US); Sriram Chidambaram, Saratoga, CA (US); Anubhav Gupta, Navi Mumbai (IN); Kumar Narayanan, Saratoga, CA (US)

(21) Appl. No.: 18/617,876

(22) Filed: Mar. 27, 2024

(51) Int. Cl. H04W 12/06; H04L 12/46; H04W 40/24; H04W 88/08

(52) U.S. Cl. CPC H04W 12/06; H04L 12/4641; H04W 40/24; H04W 88/08

(57) ABSTRACT

A wireless access point may be coupled to an input-output interface of a network device. The network device may be configured to enable VLAN configuration of the input-output interface by the wireless access point. The wireless access may send a request to the network device to update the VLAN configuration of the input-output interface in response to one or more criteria.

### BACKGROUND

A communication system includes multiple network devices that are interconnected to form a network for conveying network traffic between hosts. The network devices at the edge portions of the network can include wireless access points that provide wireless connectivity for the hosts (e.g., client devices). The wireless access points are coupled between network devices at the edge of the wired portion of the network and client devices.

### BRIEF DESCRIPTION OF THE DRAWINGS

FIG. 1 is a diagram of an illustrative network having a wireless access point to which client devices are communicatively coupled in accordance with some embodiments.

FIG. 2 is a diagram of an illustrative wireless access point in accordance with some embodiments.

FIG. 3 is a diagram of an illustrative network device in accordance with some embodiments.

FIG. 4 is a diagram of an illustrative networking system in which a network device is configured to enable VLAN configuration on a network interface coupled to a wireless access point in accordance with some embodiments.

FIG. 5 is a diagram of an illustrative wireless access point that requests a network device to associate a client VLAN to the coupled network interface of the network device in accordance with some embodiments.

FIG. 6 is a diagram of an illustrative wireless access point that receives client VLAN information from a neighboring wireless access point in accordance with some embodiments.

FIG. 7 is a flowchart of illustrative operations performed by a network device coupled to a wireless access point and for performing VLAN provisioning in accordance with some embodiments.

FIG. 8 is a flowchart of illustrative operations performed by a wireless access point coupled to a network device for performing VLAN provisioning in accordance with some embodiments.

### DETAILED DESCRIPTION

A network can convey network traffic, e.g., in the form of frames, packets, etc., between hosts or generally between devices in the network. These hosts may include client devices coupled to wireless access points in the network and, through the wireless access points, may be connected to other network devices that form a wired portion of the network.

In particular, the wired network (portion) may include an edge network device having an input-output interface coupled to a wireless access point, which provides the wireless network (portion) to which client devices may be wirelessly coupled. Different client devices may be members of different virtual local area networks (VLANs). Accordingly, the edge network device should be prepared to handle traffic for any of these client devices on any of the VLANs when the traffic is conveyed via the input-output interface because any of these client devices may connect to the wireless access point at any time. Manually configuring each input-output interface of each edge network device in the wired network to account for all possible client device connections can be tedious and often redundant because some input-output interfaces will not actually handle traffic for client devices (e.g., for corresponding VLANs) that never connect to the corresponding wireless access points on these input-output interfaces.

To improve VLAN provisioning for these input-output interfaces connected with wireless access points, a networking system may be configured to provision VLANs at edge network devices in a dynamic and secure manner. In one illustrative arrangement, the (edge) network device at the edge of the wired network may facilitate authentication of a wireless access point connected to the input-output interface of the network device. As part of the authentication process or generally after the wireless access point has been authenticated, the network device may receive an indication to enable (e.g., allow) configuration of VLAN membership for the input-output interface. The indication to enable this type of configuration may be received by the network device from an authentication server (e.g., as part of an authentication response) or from the authenticated wireless access point. Accordingly, when the wireless access point makes a determination that the VLAN membership for the input-output interface should be updated, the wireless access point may transmit a corresponding request to the network device. The determination to update VLAN membership may be based on a (new) client device connecting to and/or authenticating its connection to the network, may be based on a new or modified (updated) configuration at the wireless access point, may be in preparation for a roaming client device, and/or may be based on other criteria. If desired, in response to the network device receiving the request to update the VLAN membership from the authenticated wireless access point, the network device may be configured to identify a vendor-specific attribute (VSA) in the authentication response from the authentication server and may accept or act on the received request from the wireless access point based on the VSA indicating that such a request to update VLAN membership from the wireless access point be accepted.

In such a manner, VLAN membership of edge network device interfaces may be dynamically configured (e.g., based on the actual or anticipated connections of client devices, based on other appropriate scenarios as determined by the wireless access point, etc.). Because the wireless access point has been authenticated, its request for updating VLAN membership for its connected edge network device interface can be trusted and this dynamic VLAN provisioning scheme is secure.

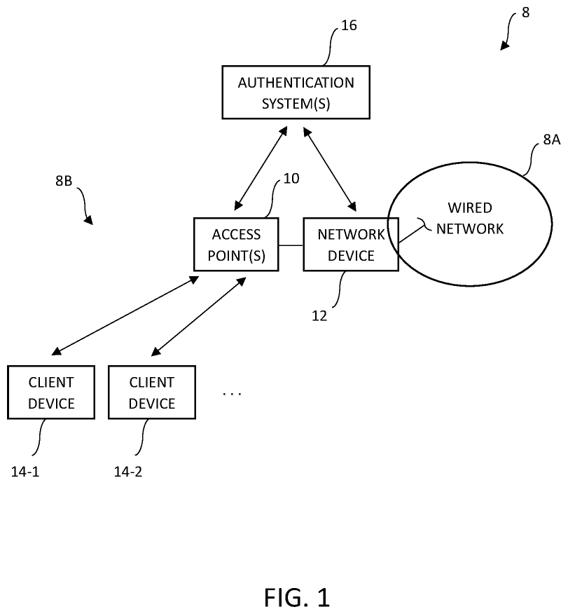

An illustrative networking system in which VLAN provisioning (e.g., dynamic VLAN provisioning as described above) may be employed is shown in FIG. 1. In the example of FIG. 1, the networking system may include one or more components of a network such as network 8. Network 8 may have any suitable scope. As examples, network 8 may include, be, and/or form part of one or more local segments, one or more local subnets, one or more local area networks (LANs), one or more virtual local area networks (VLANs), one or more campus area networks, a wide area network, etc. Network 8 may include a wired network (portion) 8A based on wired technologies or standards such as Ethernet (e.g., using copper cables and/or fiber optic cables) and a wireless network (portion) 8B such as one or more wireless local area networks (WLANs) (e.g., Wi-Fi networks compliant with the IEEE 802.11 family of standards). If desired, network 8 may also include internet service provider networks (e.g., the Internet) or other public service provider networks, private service provider networks (e.g., multiprotocol label switching (MPLS) networks), and/or other types of networks such as telecommunication service provider networks.

Network 8 may be implemented using one or more network devices that handle (e.g., process by modifying, forwarding, etc.) network traffic to convey information for user applications between end hosts and/or generally for other applications between devices. In general, network 8 can include networking equipment forming a variety of network devices that interconnect end hosts of network 8. These network devices of network 8 may include one or more wireless access points, one or more switches (e.g., multi-layer (Layer 2 and Layer 3) switches, single-layer (Layer 2) switches, etc.), one or more bridges, one or more routers or gateways, one or more hubs, one or more repeaters, one or more firewalls, one or more devices serving other networking functions, one or more devices that include the functionality of two or more of these devices, and/or management equipment that manage and control the operation of one or more of these network devices.

End hosts of network 8 can include computers, servers, portable electronic devices such as cellular telephones and laptops, other types of specialized or general-purpose host computing equipment (e.g., running one or more client-side and/or server-side applications), network-connected appliances or devices such as cameras, thermostats, wireless sensors, medical, health, or other sensors, lighting fixtures, speakers, printers, controllers, and other network-connected equipment that serve as input-output devices and/or computing devices in a distributed networking system, devices used by network administrators (sometimes referred to as administrator devices), network service devices, and/or management equipment that manage and control the operation of one or more of other end hosts and/or network devices.

As an example, network 8 may include one or more wireless access points such as wireless access point(s) 10 and another network device such as network device 12 (e.g., a switch, or more specifically, a Power over Ethernet (PoE) switch) communicatively coupled to one or more wireless access points 10 via corresponding wired connections (e.g., cables). In some illustrative embodiments described herein, network device 12 may sometimes be referred to as an edge network device 12 because it is located at an edge of wired network 8A and/or serves as an interfacing device between wireless access point 10 and other devices in wired network 8A.

One or more wireless access points 10 may implement wireless network 8B through which wireless end hosts are communicatively (e.g., wirelessly) coupled to wired network 8A. In these configurations, the end hosts connected to network 8 via wireless access points 10 are often referred to as client devices or client stations such as any suitable number of client devices 14-1, 14-2, etc., in FIG. 1 (generally referred to herein as one or more client devices 14).

To ensure that some network devices and/or hosts are authorized to connect to network 8, one or more authentication systems 16 may be communicatively coupled to network 8 (e.g., may be communicatively coupled to network device 12 and/or to access points 10, and/or may serve as some of the end hosts of network 8, etc.). In one illustrative configuration described herein as an example, authentication system(s) 16 may be implemented on server equipment (e.g., as client authentication and/or network device authentication server(s)) and may sometimes be referred to herein as authentication server(s) 16 in these configurations. The server equipment may include server hardware such as one or more blade servers, one or more rack servers, and/or one or more tower servers. Compute devices and storage devices for implementing the functions of authentication system 16 may be provided as part of the server hardware.

The compute devices may include one or more processors or processing units based on any suitable combination of processor architectures. The storage devices may include non-volatile memory such as hard disk drive storage and solid-state storage, volatile memory such as random-access memory, and/or other storage circuitry. In general, the storage devices may include one or more non-transitory (tangible) computer-readable storage media that stores the operating system software and/or any other software code, sometimes referred to as program instructions, software, data, instructions, or code. The compute devices may run (e.g., execute) an operating system and/or other software and firmware stored on the one or more non-transitory computer-readable storage media memory to perform desired operations of authentication system 16. In other illustrative arrangements, authentication system 16 may be implemented on one or more dedicated local authentication devices or generally implemented using non-server hardware.

Authentication system 16 may provide, based on compute devices executing instructions stored on storage devices, one or more authentication services (e.g., a user identity authentication service, a client device authentication service, a network device or wireless access point authentication service, etc.) by receiving authentication request messages from network devices such as network device 12 and access point 10 (e.g., to authenticate access point 10, client devices 14, etc.), by processing the request messages, by generating corresponding response messages in response to the request messages, and by transmitting the authentication response messages (e.g., indicating the result of authentication and/or other information). The request and response messages may be exchanged via any suitable communication path. As an example, these communication paths (e.g., communication path between system 16 and access point 10, communication path between system 16 and network device 12, and/or other communication paths with system 16) may include (wired) network paths through wired network 8A (e.g., through the network devices therein, using the Internet, etc.).

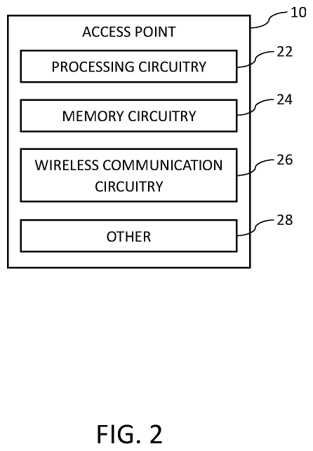

FIG. 2 is a diagram of an illustrative wireless access point such as one or more wireless access points 10 in FIG. 1. As shown in FIG. 2, wireless access point 10 may include processing circuitry 22, memory circuitry 24, wireless communication circuitry 26, and other components 28 such as input-output interfaces or ports.

Processing circuitry 22 may include one or more processors such as central processing units (CPUs), graphics processing units (GPUs), microprocessors, general-purpose processors, host processors, microcontrollers, digital signal processors, programmable logic devices (e.g., field programmable gate array (FPGA) devices), application specific system processors (ASSPs), application specific integrated circuit (ASIC) processors, and/or other types of processors. Memory circuitry 24 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry.

In general, the operations of wireless access point 10 described herein may be stored as (software) instructions on one or more non-transitory computer-readable storage media (e.g., part of memory circuitry 24) in wireless access point 10. The corresponding processing circuitry (e.g., processing circuitry 22) in wireless access point 10 for the one or more non-transitory computer-readable storage media may process the respective instructions to perform the corresponding wireless access point operations.

As an example, the VLAN provisioning operations (e.g., providing wireless access point information for authenticating the wireless access point to enable dynamic VLAN provisioning for the connected interface at the edge network device, providing a request for VLAN membership update for the connected interface at the edge network device, determining when to provide the request for VLAN membership update, etc.) as described herein and performed by wireless access point 10 may be stored as (software) instructions on the one or more non-transitory computer-readable storage media (e.g., in portion(s) of memory circuitry 24 in wireless access point 10). The corresponding processing circuitry (e.g., one or more processors of processing circuitry 22 in wireless access point 10) may process or execute the respective instructions to perform the corresponding VLAN provisioning operations.

At least some portions of processing circuitry 22 and at least some portions of memory circuitry 24, collectively, may sometimes be referred to herein as the control circuitry of wireless access point 10 because the portions are often collectively used to control one or more components of wireless access point 10 (e.g., by exchanging requests, responses, control signals, data, and/or other information with the one or more components) to perform wireless access point functions.

Wireless access point 10 may include wireless communication circuitry 26 configured to communicate wirelessly with client devices 14 (FIG. 1) and generally provide wireless communication capabilities. Wireless communication circuitry 26 may include one or more radios (e.g., Wi-Fi radios), radio-frequency transceiver circuitry, radio-frequency front-end circuitry, and one or more antennas. The one or more radios may use the one or more antennas to transmit radio-frequency signals to and receive radio-frequency signals from one or more client devices 14. While wireless communication circuitry 26 is shown as a separate element from processing circuitry 22, this is merely illustrative. If desired, portions of wireless communication circuitry 26 (e.g., radio functionalities) may be implemented as a portion of processing circuitry 22.

Access point 10 may include other components 28 such as one or more input-output interfaces (sometimes referred to herein as network interfaces), or one or more ports on which the input-output interfaces are implemented. As examples, these ports may include Ethernet ports or other types of network interfaces that generally provide wired connectivity to other network components in network 8 (e.g., network device 12 in FIG. 1), may include management ports through which wireless access point 10 is controlled and managed, may include power ports through which power is supplied to wireless access point 10, and/or may include other types of ports. In general, these input-output components 28 and/or wireless communication circuitry 26 may provide external communication interfaces (e.g., Bluetooth interfaces, Wi-Fi interfaces, Ethernet interfaces, optical interfaces at one or more optical ports, and/or other network interfaces) for connecting wireless access point 10 to a wireless local area network, a local area network, the Internet, a wide area network, a mobile network, other types of networks, and/or to external devices in network 8 such as network device 12 in FIG. 1, client device(s) 14 in FIG. 1, peripheral devices (e.g., a display), and/or other external equipment.

If desired, other components 28 on wireless access point 10 may include other input-output devices such as devices that provide user output such as a display device (e.g., one or more status lights) and/or devices that gather user input such as one or more buttons. If desired, other components 28 on wireless access point 10 may include one or more sensors such as radio-frequency sensors. If desired, wireless access point 10 may include other components 28 such as a system bus that couples the internal components of wireless access point 10 to one another, to power management components, etc. In general, each component of wireless access point 10 may be coupled to the control circuitry in wireless access point 10 (e.g., processing circuitry 22 and/or memory circuitry 24) via one or more paths that enable the reception and transmission of control signals, data, and/or other information therebetween.

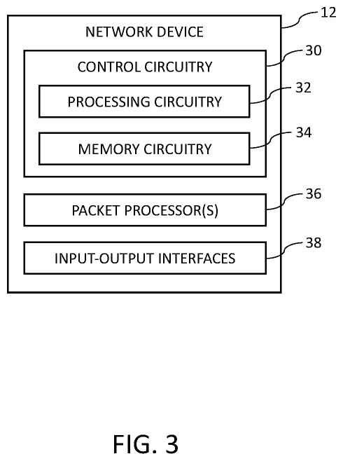

FIG. 3 is a diagram of an illustrative network device such as edge network device 12 in FIG. 1 to which one or more wireless access points 10 (FIGS. 1 and 2) are communicatively coupled (e.g., via corresponding wired connection(s), or more specifically, via direct cable connection(s)). As shown in FIG. 3, network device 12 may include control circuitry 30 having processing circuitry 32 and memory circuitry 34, one or more packet processors 36, and input-output interfaces 38. In one illustrative arrangement, network device 12 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 12 may be a fixed-configuration network device (e.g., a fixed-configuration switch having a fixed number of ports and/or a fixed hardware configuration).

Processing circuitry 32 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 32 may run (e.g., execute) a network device operating system and/or other software/firmware that is stored on memory circuitry 34. Memory circuitry 34 may include one or more non-transitory (tangible) computer-readable storage media that store the operating system software and/or any other software code, sometimes referred to as program instructions, software, data, instructions, or code. In particular, memory circuitry 34 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 12), and/or other types of memory circuitry.

As an example, the VLAN provisioning operations (e.g., enabling of dynamic VLAN membership configuration by a wireless access point, updating of VLAN membership for an interface coupled to the wireless access point, etc.) described herein and performed by network device 12 may be stored as (software) instructions on the one or more non-transitory computer-readable storage media (e.g., in portion(s) of memory circuitry 34 in network device 12). The corresponding processing circuitry (e.g., one or more processors of processing circuitry 32 in network device 12) may process or execute the respective instructions to perform the corresponding VLAN provisioning operations.

Processing circuitry 32 and memory circuitry 34 as described above may sometimes be referred to collectively as control circuitry 30 (e.g., implementing a control plane of network device 12). Accordingly, processing circuitry 32 may also sometimes be referred to as control plane processing circuitry 32. As just a few examples, processing circuitry 32 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 36, may store packet forwarding information, may execute packet processing software, and/or may execute other software instructions that control the functions of network device 12 and the other components therein.

Packet processor(s) 36 may be used to implement a data plane or forwarding plane of network device 12 and may therefore sometimes be referred to herein as data plane processor(s) 36 or data plane processing circuitry 36. Packet processor(s) 36 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 36 may receive incoming (ingress) network traffic via input-output interfaces 38, parse and analyze the received network traffic, process the network traffic based on packet forwarding decision data (e.g., in a forwarding information base) and/or in accordance with network protocol(s) or other forwarding policy, and forward (or drop) the network traffic accordingly (e.g., egress the processed network traffic via input-output interfaces 38). The packet forwarding decision data may be stored on memory circuitry integrated as part of and/or separate from packet processor 36 (e.g., on content-addressable memory), and/or on a portion of memory circuitry 34. Memory circuitry for packet processor 36 may include volatile memory, non-volatile memory, and/or other types of memory circuitry.

Input-output interfaces 38 (sometimes referred to herein as network interfaces) may include one or more different types of communication interfaces such as Ethernet interfaces, optical interfaces, and/or other types of communication interfaces for connecting network device 12 to the Internet, a local area network, a wide area network, a mobile network, and/or generally other network device(s) (e.g., wireless access points 10 in FIGS. 1 and 2), peripheral devices, and computing equipment (e.g., host equipment such as server equipment, client devices, etc.).

In illustrative configurations described herein as an example, input-output interfaces 38 may include Ethernet interfaces implemented using and therefore include (Ethernet) ports. In particular, physical layer and/or data link layer interface circuitry in network device 12 may be coupled to the ports and use the ports to form Ethernet interfaces with the desired interface configurations. The ports may be physically coupled and electrically connected to corresponding mating connectors of external equipment, when received at the ports, and may have different form-factors to accommodate different cables, different modules, different devices, or generally different external equipment.

Referring back to FIG. 1, client devices such as client devices 14 may be authenticated by authentication system 16 before being connected to wireless network 8B and generally network 8. Client devices 14 may be assigned to different virtual local area networks (VLANs) dynamically as part of the authentication process or in a predetermined manner, and/or may otherwise be indicated to be members of these VLANs. These client VLANs should be configured at wired network 8A, or more specifically, at the interfaces on edge network device 12 communicatively coupled to client devices 14 via intervening wireless access points 10 in order to properly facilitate VLAN-based traffic forwarding at edge network device 12.

Given the dynamic nature of client device wireless connections (e.g., as client devices 14 roam between different wireless access points 10, as new client devices 14 join wireless network 8B, as client devices 14 leave wireless networks 8B, etc.), all possible VLANs are configured across all edge network device interfaces to ensure that traffic is not inadvertently lost due to an incomplete interface VLAN configuration (e.g., when client devices 14 roam). However, this approach may be cumbersome for network administrators as these edge network device interfaces are often manually configured with all of the VLANs and may also be redundant as some edge network device interfaces may never handle traffic for some VLANs (e.g., client devices associated with these VLANs may never be communicatively coupled to these edge network device interfaces).

To improve VLANs provisioning (sometimes referred to herein as VLAN configuration) for edge network device interfaces connected to wireless access points, the networking system described herein may be configured to dynamically provision VLANs for these edge network device interfaces and may be configured to do so in a secure manner.

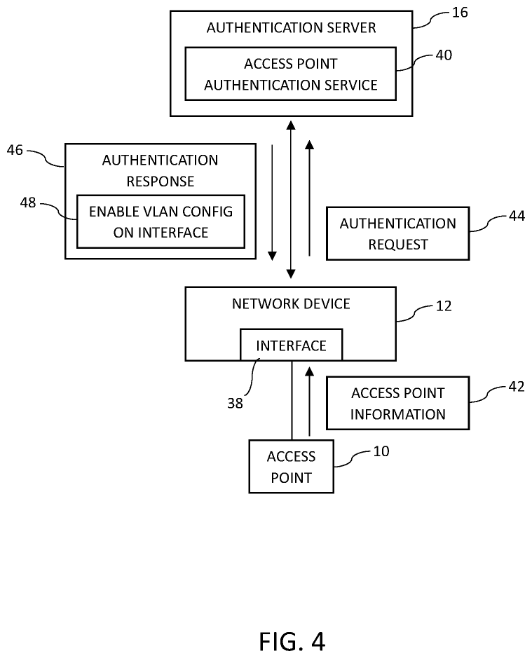

FIG. 4 is a diagram of illustrative operations of a networking system (e.g., the networking system in FIG. 1) that enables (e.g., sets up) a wireless access point to provision VLAN membership for an edge network device interface connected to the wireless access point. As shown in FIG. 4, wireless access point 10 (e.g., processing circuitry 22 in FIG. 2) may obtain access point information 42 such as an identifier (e.g., a hardware or Media Access Control (MAC) address) of access point 10, a certificate, key, or other cryptographic information for access point 10, a configuration or capability of access point 10, and/or other types of information (that may help facilitate authentication of access point 10 for connecting to network 8 and/or for establishing trust for operation as part of network 8). This information 42 may be pre-stored on memory circuitry 24 (FIG. 2) and/or may be received from other sources (e.g., obtained from a server, obtained via user input, etc.).

Processing circuitry 22 may provide (e.g., generate) a message containing information 42 (e.g., a message requesting authentication of access point 10 or generally facilitating the authentication of access point 10) and may transmit, using an input-output interface on access point 10, the message containing access point information to network device 12. Network device 12 (e.g., processing circuitry 32 in FIG. 3) may receive the message containing information 42 using edge network device interface 38 (connected to the input-output interface of access point 10 via a wired connection). In general, this edge network interface 38 may be configured to convey traffic for (e.g., to and/or from) access point 10.

Based on obtaining the message using interface 38 and in response to processing the message containing information 42, processing circuitry 32 may provide (e.g., generate) a corresponding authentication request (message) 44. Authentication request 44 may include at least some (e.g., all) of access point information 42 (to facilitate the authentication of access point 10). Processing circuitry 32 may transmit authentication request 44 (e.g., using another input-output interface of device 12 different from the interface 38 directly connected to access point 10, through network paths in network 8, and/or using any other suitable interfaces and paths) to authentication server 16 which provides access point authentication service 40 (e.g., implemented by the server compute devices executing instructions for implementing service 40 stored on server storage devices).

Responsive to receiving authentication request 44, access point authentication service 40 (e.g., the server compute devices) may process request 44 and any access point information 42 therein to determine whether or not to authenticate access point 10. As one illustrative example, the server compute devices (executing service 40) may perform one or more lookup operations and/or cryptographic operations, using access point information 42 (in request 44) as the input or key, to verify (based on the output of these operations) that access point 10 should be authenticated. Once access point 10 is validated, the server compute devices (executing service 40) may provide (e.g., generate) an authentication response (message) 46, e.g., a response indicative of successful authentication of access point 10. The server compute devices (executing service 40) may transmit, on a network interface of server 16, authentication response 44 back to network device 12 (e.g., through network paths in network 8). Upon receiving response 46, network device 12 may provide network access (e.g., connection to wired network 8A) to access point 10, thereby indicating to access point 10 of its successful authentication. In particular, access point 10 (e.g., processing circuitry 22) may obtain, from network device 12, an indication of successful authentication as a message following the reception of response 46 by network device 12.

When providing authentication response 46, the server compute devices (executing service 40) may include, in response 46, an indication 48 to enable (automatic or dynamic) VLAN configuration for interface 38 (e.g., the interface of network device 12 to which access point 10 is directly connected) when requested by now authenticated access point 10. In other words, indication 48 may enable wireless access point 10 to perform VLAN configuration (e.g., configure a VLAN membership or association) for interface 38. If desired, indication 48 may be provided (e.g., generated) and sent, by server 16, in a separate message following authentication response 46 to network device 12 and/or may be conveyed to network device 12 using any other suitable mechanism. In one illustrative configuration described herein as an example, indication 48 that causes network device 12 to enable wireless access point 10 to perform VLAN configuration for interface 38 may be included as a vendor-specific attribute (VSA) in authentication response 46, in a separate message following authentication response 46, and/or as part of another means of conveying indication 48 to network device 12. Upon receiving indication 48 at the other input-output interface (e.g., different from interface 38 shown in FIG. 4), network device 12 (e.g., processing circuitry 32 in FIG. 3) may enable VLAN configuration for interface 38 upon request by wireless access point 10.

In the illustrative authentication scheme described above in connection with FIG. 4, network device 12 may serve as the authenticator for authenticating wireless access point 10, wireless access point 10 may serve as the supplicant, and authentication server 16 may serve as the authentication server (e.g., a Remote Authentication Dial-In User Service (RADIUS) server implementing service 40). In some illustrative configurations described herein as an example, the authentication scheme described in connection with FIG. 4 may be an authentication scheme compliant or otherwise compatible with the IEEE 802.1x standard. If desired, other types of authentication schemes may instead (or additionally) be used. Following the operations described in connection with FIG. 4, wireless access point 10 may be authenticated and trusted by network device 12, and network device 12 may be ready (e.g., set up or configured) to receive requests from wireless access point to (dynamically) update VLAN configuration for interface 38.

While in the example of FIG. 4 the indication to enable VLAN configuration on interface 38 is received in authentication response message 46 from server 16, this is merely illustrative. If desired, based on wireless access point 10 being authenticated and trusted by network device 12, any suitable (e.g., trusted) source may send the indication to enable VLAN configuration on interface 38 to network device 12. As an example, based on access point 10 being authenticated (e.g., receiving an indication of successful authentication), access point 10 may itself send the indication to enable VLAN configuration on interface 38 to network device 12. In other examples, a controller or management equipment for network device 12 and/or access point 10 may send the indication to enable VLAN configuration on interface 38 to network device 12.

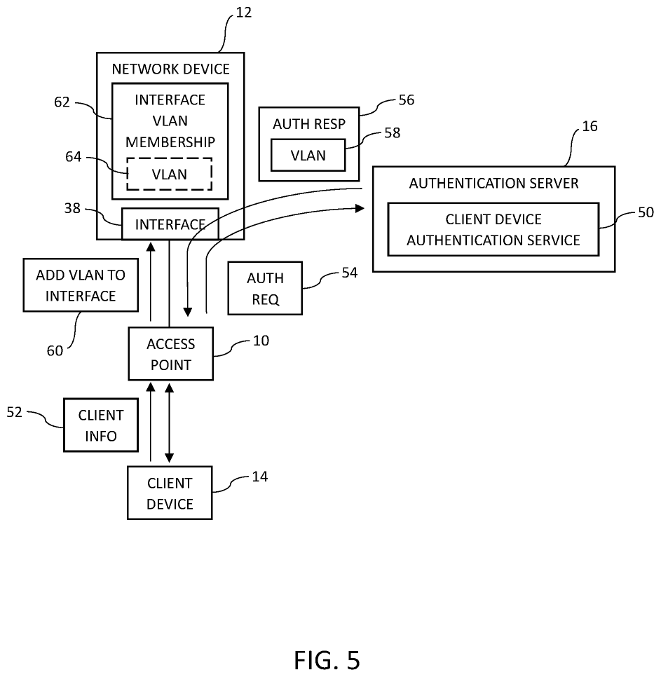

FIG. 5 is a diagram of an illustrative wireless access point (e.g., wireless access point 10 in FIGS. 1, 2, and 4) configured to perform (dynamic) VLAN provisioning based on a connecting client device. The operations described in connection with FIG. 5 may be performed after the operations described in connection with FIG. 4 have been completed (or generally when VLAN membership for interface 38 of network device 12 can be updated by request from wireless access point 10).

As shown in FIG. 5, a (newly connecting) client device 14 may transmit (e.g., using wireless communication circuitry thereon) client (device) information 52 in a message to access point 10 to facilitate authentication of client device 14 for connecting to network 8. Client information 52 in the message may include user credentials (e.g., indicative of the identity and/or role of the user of client device 14), a client device certificate, key, or other cryptographic information for client device 14, device MAC address or other identifiers for client device 14, and/or any suitable client device information (e.g., any suitable information identifying the user of the client device) usable to authenticate the connection of the client device to the network.

Wireless access point 10 (e.g., processing circuitry 22 in FIG. 2) may receive the message containing information 52 using wireless communication circuitry 26 (FIG. 2) communicatively (e.g., wirelessly) coupled to corresponding wireless communication circuitry on client device 14. Based on obtaining the message and in response to processing the message containing information 52, processing circuitry 22 may provide (e.g., generate) a corresponding authentication request (message) 54. Authentication request 54 may include at least some (e.g., all) of client information 52 (to facilitate authentication of client device 14).

Processing circuitry 22 may transmit authentication request 54 (e.g., using an input-output interface of wireless network device 10 coupled to interface 38, through interface 38 of network device 12, through network paths in network 8 and/or using any other suitable interfaces and paths) to authentication server 16 which provides client device authentication service 50 (e.g., implemented by the server compute devices executing instructions for implementing service 50 stored on server storage devices). In particular, network device 12 (e.g., one or more processors such as those implementing processing circuitry 32 and/or processing circuitry 36 in FIG. 3) may be configured to forward request 54 received at a first interface 38 (shown in FIG. 5) for egress at another input-output interface of device 12 and ultimately to server 16.

Authentication server(s) 16 as shown in FIGS. 4 and 5 may be the same server or different servers. If desired, a single authentication service executed on corresponding server equipment (e.g., implemented by server compute devices executing instructions on server storage devices) may be used to authenticate both wireless access points and client devices, thereby implementing both service 40 (FIG. 4) and service 50 (FIG. 5).

Responsive to receiving authentication request 54, client device authentication service 50 (e.g., the server compute devices) may process request 54 and any client information 52 therein to determine whether or not to authenticate client device 14. As one illustrative example, the server compute devices (executing service 50) may perform one or more lookup operations and/or cryptographic operations, using client information 52 (in request 54) as the input or key, to verify (based on the output of these operations) that client device 14 should be authenticated. Once client device 14 is validated, the server compute devices (executing service 50) may provide (e.g., generate) an authentication response (message) 56, e.g., a response indicative of successful authentication of client device 14. The server compute devices (executing service 50) may transmit, on a network interface of server 16, authentication response 56 back to wireless access point 10 (e.g., through network paths in network 8 and through network device 12). In particular, network device 12 (e.g., one or more processors such as those implementing processing circuitry 32 and/or processing circuitry 36 in FIG. 3) may be configured to forward response 56 received at another input-output interface of device 12 for egress at interface 38 and ultimately to wireless access point 10.

When providing authentication response 56, the server compute devices (executing service 50) may include, in response 56, an indication 58 of one or more VLANs associated with now authenticated client device 14 (e.g., to which client device 14 belongs or of which client device 14 is a member). If desired, indication 58 may be provided (e.g., generated) and sent, by server 16, in a separate message following authentication response message 56 to access point 10 and/or may be conveyed to client device 10 using any other suitable mechanism (e.g., may be pre-stored on client device 10 or obtained from another server or source). As examples, indication 58 may be the identifier(s) for the VLAN(s), may be role information for the user of client device 14 (whose role is associated with the VLAN(s)), may be any other suitable form of VLAN membership information for client device 14.

In the illustrative authentication scheme described above in connection with FIG. 5, access point 10 may serve as the authenticator for authenticating client device 14, client device 14 may serve as the supplicant, and authentication server 16 may serve as the authentication server (e.g., a Remote Authentication Dial-In User Service (RADIUS) server implementing service 50). In some illustrative configurations described herein as an example, the authentication scheme described in connection with FIG. 5 may be an authentication scheme compliant or otherwise compatible with the IEEE 802.1x standard. If desired, other types of authentication schemes may instead (or additionally) be used. In particular, in the example of FIG. 5, network device 12 (e.g., one or more processors of network device 12) is configured to forward authentication request 54 and authentication response 56. This is merely illustrative. If desired, authentication request 54, authentication response 56, and/or other communication between wireless access point 10 and server 16 may be exchanged using any other suitable paths (e.g., network paths in network 8 that bypass network device 12, a wired connection between access point 10 and server 16, etc.).

Following the operations described in connection with FIG. 5, client device 14 may be authenticated and trusted by network 8, and certain network resources may be accessible to client device 14 (depending on the role and/or type of client device and/or its user).

Upon receiving indication 58 of client VLAN(s) at an input-output interface of wireless access point 10 or generally based on obtaining indication 58 (e.g., from other sources), wireless access point 10 (e.g., processing circuitry 22) may determine that an update to the VLAN configuration for interface 38 is desired for network device 12 to properly perform VLAN-based forwarding for client device 14. In particular, processing circuitry 22 may make this determination based on indication 58 being obtained as a result of client authentication response (indicating client device 14 is new client device) and/or based on the VLAN(s) indicated by indication 58 not being previously provisioned on interface 38 (e.g., processing circuitry 22 not having previously requested provisioning of the VLAN(s) on interface 38).

Processing circuitry 22 may provide (e.g., generate) a request to update VLAN membership for interface 38 coupled to access point 10 based on indication 58 (e.g., the VLAN(s) indication by indication 58 that should be provisioned for interface 38). Processing circuitry 22 may transmit, using the input-output interface on wireless access point 10 coupled to interface 38, the request to network device 12 to update VLAN membership for interface 38. In the example of FIG. 5, the request may be a VLAN join (e.g., add) request 60 containing (or otherwise indicating) the client VLAN(s) identified by authentication response 56 (e.g., by indication 58 therein) to be added for interface 38.

Network device 12 (e.g., processing circuitry 32 in FIG. 3) may receive, using interface 38, the request (e.g., request 60) containing a VLAN membership update and process the request to perform the VLAN membership update based on determining that VLAN configuration of interface 38 by wireless access point 10 is enabled (e.g., by performing the operations described in connection with FIG. 4). In particular, based on the enabled VLAN configuration setting, processing circuitry 32 may update interface VLAN membership information 62 (e.g., an interface VLAN membership table or generally an interface to VLAN mapping) stored on memory circuitry (e.g., memory circuitry 34 in FIG. 2 and/or memory circuitry associated with data plane processing circuitry 36) for interface 38. In general, updating VLAN membership information 62 for interface 38 may include associating VLANs to interface 38 (e.g., in the case of a VLAN join request) or disassociating VLANs from interface 38 (e.g., in the case of a VLAN leave request). In the example of FIG. 5, based on request 60 being a VLAN join request, processing circuitry 32 may update VLAN membership 62 for interface 38 to include one or more VLANs 64 indicated in request 60 (e.g., one or more VLANs indicated by indication 58).

One or more processors of network device 12 (e.g., control plane processing circuitry 32 and/or data plane processing circuitry 36) may be configured to use the updated VLAN membership information 62 for interface 38 to perform traffic forwarding operations (e.g., to process traffic to and/or from client device 14). In other words, the updated VLAN membership information 62 may help facilitate the proper VLAN-to-VLAN isolation and/or other VLAN-based technologies (e.g., VLAN-to-VLAN bridging) for client device 14.

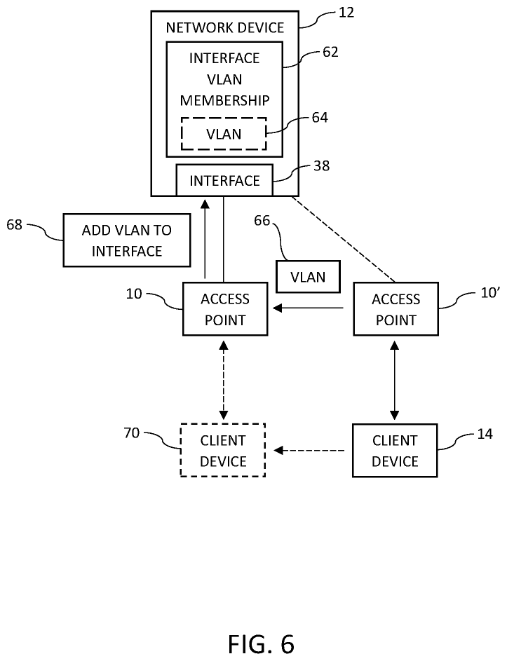

While FIG. 5 provides an example in which wireless access point 10 requests an update of VLAN membership for interface 38 based on a client device authentication operation and/or based on client device 14 being already wirelessly coupled to wireless access point 10, this is merely illustrative. If desired, wireless access point 10 may request an update of VLAN membership for interface 38 in other contexts, based on other criteria, and/or generally based on other determinations made by wireless access point 10. As another example, FIG. 6 is a diagram of an illustrative access point configured to perform VLAN provisioning based on an indication from a neighboring access point (e.g., in anticipation of client device roaming).

In the example of FIG. 6, wireless access point 10 may be coupled (e.g., via a wired connection) to interface 38 of network device 12 for which (dynamic) VLAN configuration by access point 10 is enabled (e.g., by completing the operations described in connection with FIG. 4). Thereafter, wireless access point 10 may receive a message from another (neighboring) wireless access point 10′ (e.g., another instance of the wireless access point described in connection with FIGS. 1 and 2). Wireless access point 10′ may be an access point that is a radio-frequency neighbor of access point 10 based on a received signal strength (e.g., for a signal transmitted by access point 10′ and received by access point 10) meeting a signal strength threshold and/or based on other criteria being met as determined by processing circuitry 22 (FIG. 2) of access point 10. Access point 10′ may have an input-output interface coupled (e.g., via a wired connection) to another interface of the same network device 12 (coupled to access point 10) or may have an input-output interface coupled (e.g., via a wired connection) to an interface of another edge network device (e.g., another PoE switch in wired network 8A).

In one illustrative configuration described herein as an example, the message from access point 10′ may be conveyed using radio-frequency signals, and processing circuitry 22 of access point 10 may use wireless communication circuitry 26 (FIG. 2) to receive the message from access point 10′. If desired, the message from access point 10′ may be conveyed using a wired path (e.g., through edge network device 12 and/or other network device(s) in wired network 8A), and processing circuitry 22 of access point 10 may receive the message from access point 10′ through an input-output interface of access point 10 coupled to interface 38 of network device 12.

The message from wireless access point 10′ may include an indication 66 of VLAN(s) for a client device 14 wirelessly coupled to access point 10′ but not yet wirelessly coupled to wireless access point 10. As examples, indication 66 may be the identifier(s) for the VLAN(s), may be role information for the user of client device 14 (whose role is associated with the VLAN(s)), may be any other suitable form of VLAN membership information for client device 14. Wireless access point 10′ may have already performed the operations described in connection with FIGS. 4 and 5 to provision the VLAN(s) for its connected client device 14 to its connected edge network device interface on network device 12 (or another edge network device). In anticipation of client device 14 roaming to a neighboring access point (e.g., wireless access point 10 from the perspective of wireless access point 10′), wireless access point 10′ may transmit (e.g., broadcast using radio-frequency signals) the message containing indication 66 of VLAN(s) to any neighboring access points including access point 10.

Upon processing circuitry 22 of wireless access point 10 receiving indication 66 of the not-yet-connected client VLAN(s) or otherwise obtaining indication 66 (e.g., from other sources such as network device 12 or an authentication server or management system managing access points 10 and 10′), processing circuitry 22 of wireless access point 10 may determine that an update to the VLAN configuration of interface 38 is desired for network device 12 to properly perform VLAN-based forwarding for client device 14 (in case client device 14 roams to and is wirelessly coupled to wireless access point 10 with little notice beforehand). In particular, processing circuitry 22 of access point 10 may make this determination based on indication 66 being obtained based on a client roaming scenario and/or based on the VLAN(s) indicated by indication 66 not being previously provisioned on interface 38 (e.g., processing circuitry 22 of access point 10 not having previously requested provisioning of the VLAN(s) on interface 38).

Processing circuitry 22 of access point 10 may provide (e.g., generate) a request to update VLAN membership for interface 38 coupled to access point 10 based on indication 66 (e.g., the VLAN(s) indicated by indication 66 that should be provisioned for interface 38). Processing circuitry 22 of access point 10 may transmit, using the input-output interface on wireless access point 10 coupled to interface 38, the request to network device 12 to update VLAN membership for interface 38. In the example of FIG. 6, the request may be a VLAN join (e.g., add) request 68 containing (or otherwise indicating) the client VLAN(s) identified by the message received from access point 10′ (e.g., by indication 66 therein) to be added for interface 38.

Network device 12 (e.g., processing circuitry 32 in FIG. 3) may receive, using interface 38, the request (e.g., request 68) containing a VLAN membership update and process the request to perform the VLAN membership update based on determining that VLAN configuration of interface 38 by wireless access point 10 is enabled (e.g., by performing the operations described in connection with FIG. 4). In particular, based on the enabled VLAN configuration setting, processing circuitry 32 may update interface VLAN membership information 62 (e.g., an interface VLAN membership table or generally an interface to VLAN mapping) stored on memory circuitry (e.g., memory circuitry 34 in FIG. 2 and/or memory circuitry associated with data plane processing circuitry 36) for interface 38. In general, updating VLAN membership information 62 for interface 38 may include associating VLANs to interface 38 (e.g., in the case of a VLAN join request) or disassociating VLANs from interface 38 (e.g., in the case of a VLAN leave request). In the example of FIG. 6, based on request 68 being a VLAN join request, processing circuitry 32 may update VLAN membership 62 for interface 38 to include one or more VLANs 66 indicated in request 68 (e.g., one or more VLANs indicated by indication 66).

One or more processors of network device 12 (e.g., control plane processing circuitry 32 and/or data plane processing circuitry 36) may be configured to use the updated VLAN membership information 62 for interface 38 to perform traffic forwarding operations (e.g., to process (future) traffic to and/or from anticipated roaming client device 14). In other words, the updated VLAN membership information 62 may help facilitate the proper VLAN-to-VLAN isolation and/or other VLAN-based technologies (e.g., VLAN-to-VLAN bridging) for client device 14.

While FIGS. 5 and 6 show illustrative examples for dynamically adding VLANs to an edge network device interface (e.g., the addition of VLANs to the interface VLAN membership information), network device 12 (e.g., processing circuitry 32 in FIG. 3) may also dynamically remove one or more existing VLAN(s) from an interface (e.g., interface 38 in FIGS. 5 and 6). In general, once the dynamical VLAN configuration setting is enabled by processing circuitry 32 of network device 12 for interface 38 (FIGS. 5 and 6), access point 10 (e.g., processing circuitry 22 in FIG. 2) may provide and transmit a VLAN update request message to make any suitable change to the edge network device interface (e.g., a VLAN join request to add a VLAN, a VLAN leave request to remove a VLAN, a combination request to add and remove VLANs, etc.).

The generation and transmission of the VLAN update request message may be responsive to access point 10 (e.g., processing circuitry 22) identifying any suitable network event (e.g., determining based on a current event, anticipating based on a future event, etc.) indicating a change to the VLAN configuration for connected client devices 14 (FIG. 5) and/or (roaming) client devices 14 (FIG. 6) possibly to be connected, and therefore a change to the VLAN membership of interface 38 handling (anticipated) traffic for these client devices 14. In some instances, the network event based on which the VLAN update request message is generated and transmitted (e.g., indicating a change to the VLAN configuration) may be a configuration change (e.g., a new configuration, an updated or modified configuration, etc.) at access point 10. In particular, access point 10 may be (pre-)configured with one or more (default) VLANs, tunnel VLANs, other VLANs not necessarily obtained based on connected or roaming client devices 14 (e.g., as described in connection with FIGS. 5 and 6), and/or updated versions of these types of VLANs. Accordingly, access point 10 (e.g., processing circuitry 22) may similarly generate and transmit VLAN update request messages containing VLAN join requests to add default VLANs, tunnel VLANS, other VLANs configured (e.g., by a network administrator) on access point 10, other types of VLANs not necessarily obtained based on connected or roaming client devices 14, and/or updated versions of these types of VLANs to the interface VLAN membership for interface 38 directly coupled with wireless access point 10.

If desired, network device 12 (e.g., processing circuitry 32) and/or access point 10 (e.g., processing circuitry 22) may be configured to implement a timeout mechanism that removes or requests removal of a VLAN after a timeout time period. This timeout period may be based on or follow a client device disconnecting from access point 10. In other words, if desired, the update message sent from access point 10 to network device 12 may include indications of the client disconnecting from access point 10, indications of client device timeout (e.g., as a VLAN leave request), periodic indications of connected client devices, and/or other information for the timeout mechanism and for updating the timeout time period. In other instances, network device 12 (e.g., processing circuitry 32) may itself determine these types of indications based on communication with access point 10 and/or may periodically remove one or more VLANs based on determining these types of indications. In general, network device 12 (e.g., processing circuitry 32) and/or access point 10 (e.g., processing circuitry 22) may remove or request removal of one or more VLANs (e.g., via VLAN leave requests) based on any suitable network event (e.g., one or more criteria being met when the network event indicating removal of VLAN(s) occurs) such as a determination by processing circuitry 32 and/or 22 that one or more VLANs are no longer needed.

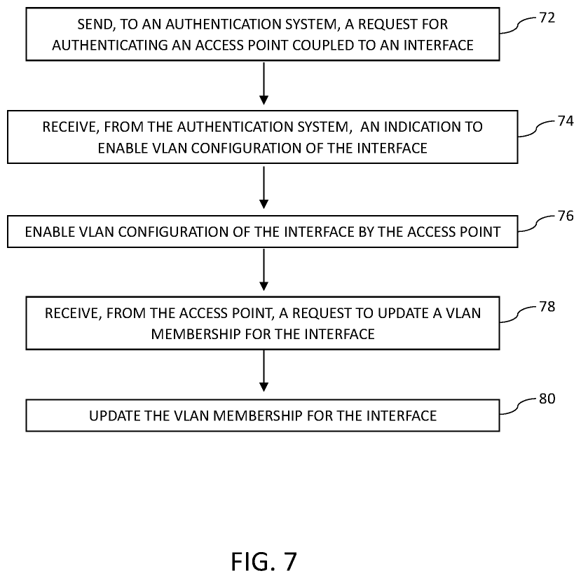

FIG. 7 is a flowchart of illustrative operations performed by an edge network device (e.g., network device 12 in FIGS. 1 and 3-6) having an input-output interface communicatively coupled (e.g., via a wired connection) to an access point and configured to perform dynamic VLAN provisioning. In particular, these operations may be performed by processing circuitry 32 (FIG. 3) of network device 12 using other components of network device 12 (e.g., memory circuitry 34, processing circuitry 36, and/or interfaces 38 in FIG. 3). In configurations described herein as an illustrative example, the operations described in connection with FIG. 7 may be performed by processing circuitry 32 executing software instructions stored on memory circuitry 34. If desired, one or more operations described in connection with FIG. 7 may be performed by other hardware components in network device 12.

At block 72, one or more processors of an edge network device (e.g., forming control plane processing circuitry 32 and/or data plane processing circuitry 36 of device 12) may generate and send a request for authenticating a wireless access point coupled to a first input-output interface of the edge network device. In particular, the request may be sent using a second input-output interface of the edge network device communicatively coupled to an authentication system.

At block 74, the one or more processors may receive, from the authentication system, an indication to enable VLAN configuration of the first interface. The indication may be a VSA indicating that the one or more processor (of the edge network device) allow or accept VLAN configuration updates (e.g., VLAN membership changes) from the wireless access point. If desired, this indication to enable VLAN configuration may be received by the one or more processors from the (authenticated) wireless access point instead of or in addition to the authentication system.

At block 76, the one or more processors may enable VLAN configuration of the interface by the access point. This may be done based on receiving the indication (at block 74) and/or based on the access point being authenticated.

In general, the operations described in connection with blocks 72, 74, and 76 may include any of the operations described in connection with FIG. 4 to enable dynamic VLAN configuration of the edge network device interface as performed by the edge network device (e.g., network device 12).

At block 78, the one or more processors may receive, from the access point and using the edge network device interface coupled to the access point, a request to update (e.g., configure) a VLAN membership for the edge network device interface.

At block 80, the one or more processors may update the VLAN membership for the edge network device interface. This may be done responsive to receiving the request (at block 78) and/or based on determining that the VLAN configuration setting for the network device interface is enabled and that the access point is authorized to update the VLAN configuration (e.g., based on the indication received at block 74 indicating that the VLAN configuration updates from the wireless access point should be accepted or acted on).

In general, the operations described in connection with blocks 78 and 80 may include any of the operations described in connection with FIGS. 5 and 6 (and generally herein) performed by the edge network device to dynamically update VLAN configuration of the edge network device interface when requested by the access point.

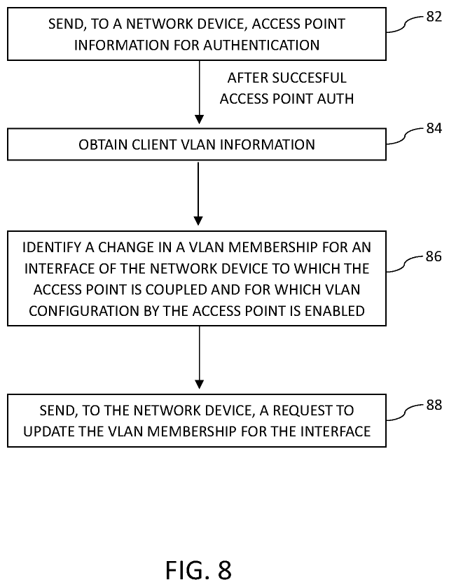

FIG. 8 is a flowchart of illustrative operations performed by a wireless access point (e.g., wireless access point 10 in FIGS. 1, 2, and 4-6) having an input-output interface communicatively coupled (e.g., via a wired connection) to an edge network device and configured to perform dynamic VLAN provisioning. In particular, these operations may be performed by processing circuitry 22 (FIG. 2) of wireless access point 10 using other components of wireless access point 10 (e.g., memory circuitry 24, wireless communication circuitry 26, and/or other components 38 such as input-output interfaces in FIG. 2). In configurations described herein as an illustrative example, the operations described in connection with FIG. 8 may be performed by processing circuitry 22 executing software instructions stored on memory circuitry 24. If desired, one or more operations described in connection with FIG. 7 may be performed by other hardware components in wireless access point 10.

At block 82, one or more processors of a wireless access point (e.g., forming processing circuitry 22 of wireless access point 10) may send, to an edge network device coupled to the wireless access point and using an input-output interface of the wireless access point (e.g., other components 30 in FIG. 2), access point information as part of an authentication request for authenticating the wireless access point to the network. Thereafter, the wireless access point may be authenticated by an authentication system.

In general, the operations described in connection with block 82 may include any of the operations described in connection with FIG. 4 to enable dynamic VLAN configuration of the edge network device interface as performed by the wireless access point (e.g., wireless access point 10).

At block 84, the one or more processors may obtain client VLAN information. As examples, the one or more processors may obtain client VLAN information by receiving, using the input-output interface of the wireless access point, the client VLAN information from an authentication server (e.g., server 16 in FIG. 5) as part of a client device authentication response and/or by receiving, using wireless communication circuitry (e.g., wireless communication circuitry 26 in FIG. 2), the client VLAN information from a neighboring access point (e.g., wireless access point 10′ in FIG. 6).

At block 86, the one or more processors may identify a change in a VLAN membership for the interface of the edge network device to which the wireless access point is coupled and for which VLAN configuration by the wireless access point is enabled. As examples, the changes may include a change to associate one or more VLANs to the edge network device interface and/or a change to disassociate one or more VLANs from the edge network device interface.

At block 88, the one or more processors may generate and send, to the edge network device and using the input-output interface of the wireless access point, a request to update the VLAN membership for the edge network device interface.

In general, the operations described in connection with blocks 86 and 88 may include any of the operations described in connection with FIGS. 5 and 6 (and generally herein) performed by the wireless access point to dynamically update VLAN configuration of the edge network device interface by request.

The methods and operations described above in connection with FIGS. 1-8 may be performed by the components of one or more wireless access points and/or server or other host equipment using software, firmware, and/or hardware (e.g., dedicated circuitry or hardware). Software code for performing these operations may be stored on non-transitory computer-readable storage media (e.g., tangible computer readable storage media) stored on one or more of the components of the wireless access point(s) and/or server or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the wireless access point(s) and/or server or other host equipment (e.g., compute devices of system 16 in FIG. 1, processing circuitry 22 of wireless access point 10 in FIG. 2, processing circuitry 32 of network device 12 in FIG. 3, etc.).

The foregoing is merely illustrative and various modifications can be made to the described embodiments. The foregoing embodiments may be implemented individually or in any combination.

What is claimed is:

1. A network device comprising:
an input-output interface configured to convey traffic for a wireless access point;
memory circuitry configured to store virtual local area network (VLAN) information for the input-output interface; and
one or more processors coupled to the memory circuitry and the input-output interface and configured to:
obtain an indication to enable the wireless access point to configure the VLAN information for the input-output interface;
receive, using the input-output interface, a wireless access point request to update the VLAN information for the input-output interface; and
update the VLAN information based on the received wireless access point request.

2. The network device defined in claim 1, wherein the one or more processors are configured to obtain the indication to enable the wireless access point to configure the VLAN information for the input-output interface based on an indication of the wireless access point being authenticated.

3. The network device defined in claim 2, wherein the one or more processors are configured to:
provide an authentication request for authenticating the wireless access point; and
receive an authentication response in response to the authentication request, wherein the authentication response includes the indication of the wireless access point being authenticated.

4. The network device defined in claim 3, wherein the authentication response includes the indication to enable the wireless access point to configure the VLAN information for the input-output interface.

5. The network device defined in claim 4, wherein the wireless access point request to update the VLAN information for the input-output interface includes one or more VLANs in a client device authentication response, in a new configuration of the wireless access point, or in an updated configuration of the access point.

6. The network device defined in claim 1, wherein the wireless access point request comprises a VLAN join request identifying a VLAN and wherein the one or more processors are configured to update the VLAN information by associating the VLAN with the input-output interface.

7. The network device defined in claim 6, wherein the one or more processors are configured to forward a request for client authentication for a client device communicatively coupled to the wireless access point and forward a response for client authentication for the client device, and wherein the response for client authentication contains an indication of the VLAN.

8. The network device defined in claim 7, wherein the one or more processors are configured to forward the response for client authentication for egress at the input-output interface and wherein the one or more processors are configured to receive the wireless access point request by receiving the wireless access point request after forwarding the response for client authentication for egress at the input-output interface.

9. The network device defined in claim 1, wherein the wireless access point request comprises a VLAN leave request identifying a VLAN and wherein the one or more processors are configured to update the VLAN information by disassociating the VLAN from the input-output interface.

10. The network device defined in claim 1, wherein the one or more processors comprise control plane processing circuitry and data plane processing circuitry, wherein the wireless access point request to update the VLAN information is for a client device communicatively coupled to the wireless access point or communicatively coupled to a neighboring access point of the wireless access point, and wherein the one or more processors are configured to forward traffic for the client device conveyed using the input-output interface based on the updated VLAN information.

11. A wireless access point comprising:
wireless communication circuitry;
memory circuitry; and
processing circuitry coupled to the wireless communication circuitry and the memory circuitry and configured to:
transmit, to a network device, a message for authenticating the wireless access point;
obtain an indication of successful wireless access point authentication; and
transmit, to the network device, a virtual local area network (VLAN) update request for updating a VLAN configuration for an input-output interface of the network device coupled to the wireless access point.

12. The wireless access point defined in claim 11, wherein the VLAN update request comprises a VLAN join request that identifies a VLAN to be associated with the input-output interface.

13. The wireless access point defined in claim 12, wherein the processing circuitry is configured to perform a client device authentication operation and is configured to obtain an indication of the VLAN based on the client device authentication operation and wherein the processing circuitry is configured transmit the VLAN update request based on the client device authentication operation.

14. The wireless access point defined in claim 13, wherein the processing circuitry is configured to perform the client device authentication operation by transmitting a client device authentication request and by receiving a client device authentication response that includes the indication of the VLAN.

15. The wireless access point defined in claim 12, wherein the processing circuitry is configured to obtain an indication of the VLAN from a neighboring wireless access point and wherein the processing circuitry is configured to transmit the VLAN update request based on a client device roaming from the neighboring wireless access point.

16. The wireless access point defined in claim 15, wherein the VLAN contains, as a member, the client device communicatively coupled to the neighboring wireless access point and not communicatively coupled to the wireless communication circuitry of the wireless access point.

17. The wireless access point defined in claim 11, wherein the VLAN update request comprises a VLAN leave request that identifies a VLAN to be disassociated from the input-output interface.

18. The wireless access point defined in claim 11, wherein the VLAN update request causes the network device to update, when a VLAN configuration setting is enabled, VLAN membership information for the input-output interface based on the VLAN update request.

19. A method of provisioning a virtual local area network (VLAN), the method comprising:
authenticating a wireless access point coupled to an input-output interface of an edge network device;
sending an indication to enable configuration of a VLAN membership for the input-output interface and by the wireless access point;
authenticating a client device coupled to the wireless access point; and
sending an indication of a VLAN associated with the client device to the wireless access point, wherein the wireless access point is operable to update the VLAN membership for the input-output interface to include the VLAN.

20. The method defined in claim 19, wherein the indication to enable configuration of the VLAN membership for the input-output interface and by the wireless access point is based on the wireless access point being authenticated and wherein the indication of the VLAN associated with the client device is part of an authentication response message for authenticating the client device.
